(19) United States
(12) Patent Application Publication
(10) Pub. No.: US 2006/0191733 A1
(43) Pub. Date: Aug. 31, 2006

(54) Electronic vehicle interface integrated with a steering wheel rotating apparatus for physically handicapped

(76) Inventor: Gregory Jacques Paquin, Los Angeles, CA (US)

Correspondence Address: GREGORY J. PAQUIN, 6437 W. 77TH ST., LOS ANGELES, CA, 90045, US

(21) Appl. No.: 11/067,056

(22) Filed: Feb. 28, 2005

(51) Int. Cl. B60K 26/00; G05G 1/10

(52) U.S. Cl. 180/333; 74/553

(57) ABSTRACT

The invention provides a steering wheel rotating apparatus with electrical contact mechanisms, having interface with the vehicle to signal an electronic control device. This is accomplished by connecting the signal wire and grounding contact to a two conductor electrical plug having a matching jack cable mountable in the steering wheel and connected to a vehicle wire using the vehicle clockspring assembly and to a ground source. Having the steering column side of the same clockspring circuit in the steering wheel, the plug cable is connected. A ground wire of the plug cable is also provided. The plug cable is plugged into the electronic control device. Having a microcomputer to determine which electrical contact mechanism is being activated by the operator and the duration of the contact, the microcomputer program can activate different operations. This permits more operations than electrical contact mechanisms on the a steering wheel rotating apparatus.

### BACKGROUND OF THE INVENTION

1. Field of the Invention

This invention relates to a vehicle secondary operation controller integrated with a steering wheel rotating apparatus to be used by physically handicapped persons in operating automobiles and more particularly to electrical contact mechanisms on a steering wheel rotating apparatus so that physically handicapped persons can control secondary vehicle functions and the steering wheel with one hand when the brake and accelerator are manually operated with the other hand.

2. Description of the Prior Art

Generally, the accelerator and brake of an automobile are operated with a right foot, a person physically handicapped in the lower limbs cannot operate the brake and accelerator. Therefore, various automobile primary control operating apparatus for physically handicapped persons have been proposed so that the accelerator and brake may be manually operated with a hand. This method permits rotation of the steering wheel with the other hand and inhibits the operator's ability to control vehicle secondary functions. Prior apparatus provided switches attached to the grip holder, having a fixed position on the steering wheel and changing position with the operator's hand as the steering wheel rotates. In this apparatus, electrical contact mechanisms are fitted to the steering wheel rotating apparatus in the driver's hand and maintain consistent orientation to the hand while steering wheel rotation occurs.

If a non-handicapped person is to ordinarily operate the steering wheel, the gripping part of the rotary knob is detachable from the steering wheel, interface with vehicle secondary controls using original manufacturer equipment remains operational.

### SUMMARY OF THE INVENTION

A first object of the present invention is to provide a means of controlling vehicle secondary functions from the steering wheel rotating apparatus for physically handicapped persons wherein the steering wheel can be easily operated with one hand by a physically handicapped person who manually operates the accelerator and brake apparatus. Secondary functions including, but not limited to; horn, turn signals, hi-beam, wiper, wash, cruise control and window up/down.

A second object of the present invention is to provide a steering wheel rotating apparatus for physically handicapped persons wherein, if a non-handicapped person is to operate the automobile, the rotary gripping part will be removed by one touch so as not to interfere with ordinary steering wheel operation.

According to the present invention, there is provided a steering wheel rotating apparatus for physically handicapped persons wherein a grip holder having a grip fitting hole and an engaging member projectable from the inside surface of said grip fitting hole is fixed to the steering wheel of an automobile, and a rotary grip having a shaft fittable into said fitting hole and a grip body part rotatably fitted to said shaft can be removably fitted into the grip holder by the operation of the engaging member. Having electrical contact mechanisms located on the steering wheel rotating apparatus in positions reachable and comfortable for the physically handicapped persons to operate with minimum fatique. Any number of electrical contact mechanisms, having locations on the steering wheel rotating apparatus which include, but not limited to the underside, the side and the top to best allow the physically handicapped operator to comfortably perform the desired vehicle fuction. A grip holder having electrical contact surface to provide electrical signals from the rotary grip to an electronic control device. Having to an electronic control device to interface to the vehicle electrical systems for operation of secondary vehicle functions.

The invention having a microcomputer. Said microcomputer is programmed to provide a method of operating more the one function from an electrical contact mechanism. The invention thus having cortrol over more vehicle secondary functions than electrical contact mechanisms on the steering wheel rotating apparatus.

### BRIEF DESCRIPTION OF THE DRAWINGS

The above described objects and the other objects of the present invention will be made apparent by the following descriptions and appended drawings. Embodiments of the present invention are exemplified in these descriptions and drawings but it is apparent that various modifications can be made within the scope of the claims.

FIG. 1 is a view showing a first embodiment of a steering wheel rotating apparatus for physically handicapped persons according to the present invention of the apparatus. Having electrical contact mechanisms located in various location on the grip;

FIG. 2 is a view showing a first embodiment of a steering wheel rotating apparatus for physically handicapped persons according to the present invention of FIG. 1. Showing the steering wheel rotating apparatus and the grip holder and the grip holder securement method to the vehicle steering wheel,

FIG. 3 is a partly sectioned view for explaining the engaging member, the electrical pressure contact surface and the electrical wiring connections,

FIG. 4 is an illustration of the electrical path between the a steering wheel rotating apparatus and the control device, showing the grip holder, electrical pressure contact surface and the vehicle steering wheel mechanism:

FIG. 5 is a plan view showing a second embodiment of the present invention illustrating a radio frequency alternative for signaling the control device;

### DETAILED DESCRIPTION OF PREFERRED EMBODIMENTS

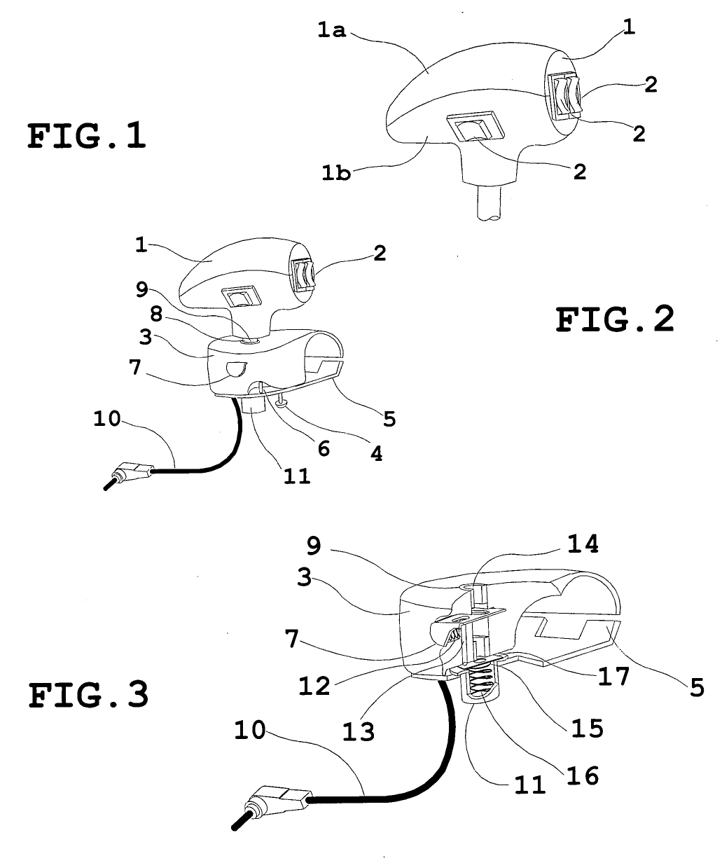

Referring initially to FIG. 1, of a first embodiment of the present invention is shown in which the reference numeral 1 represents the steering wheel rotating apparatus, made of a resin and fitted to a shaft. Also shown is the placement of the electrical contact mechanisms 2 as in a typical application in the steering wheel rotating apparatus 1. The steering wheel rotating apparatus is fitted with an upper member 1a and a lower member 1b. The upper member 1a is produced in a variety of colors to provide aesthetic elements. Other location and types of electrical contact mechanisms can be used to enable operation by the physically handicapped operator.

FIG. 2 describes the present invention as seen by the vehicle operator. The grip holder 3 is secured to the steering wheel of an automobile by screws 4 providing pressure on a retaining plate 5. Additional fasteners 6 are used to level the retaining plate 5. 7 represents an engaging member to retain the grip shaft 8 of the steering wheel rotating apparatus 1, removably fitted to the grip holder 3 and used in retaining the steering wheel rotating apparatus. The grip holder 3 is provided with a steering wheel rotating apparatus hole 9 in the form of a circle through hole first and second open ends in opposite sides and is fitted with an engaging member 7. A two conductor electrical plug wire 10 is connected to an electrical pressure contact surface housing 11 and a ground providing the signal to the electronic control device.

FIG. 3 illustrates a partly section drawing showing the spring 12 and the retaining screw 13 of the engaging member 7. The spring 12 applies pressure on the engaging member 7 to retain the grip shaft 8 at a machined groove in the grip shaft 8 when fitted into the grip holder fitting hole 9 having bearings 14 on the upper and lower ends of the grip holder fitting hole 9. The electrical pressure contact surface 15 and the contact spring 16 are enclosed by the electrical pressure contact surface housing 11. 17 represents a ground wiring spring connection, fixed by a screw, provides ground for the signal to the control device which interfaces with the automobile's secondary functions so that a horn will sound, the turn signals will flash and other functions will operate when the specific electric contact mechanism 2 is engaged.

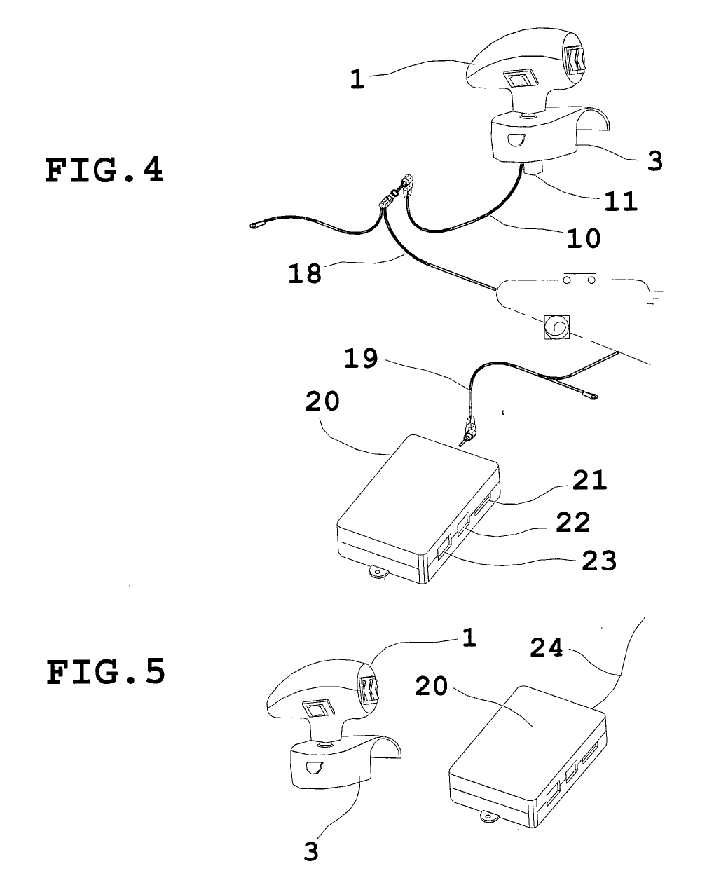

FIG. 4 describes the electrical path from the a steering wheel rotating apparatus 1 through the grip holder 3 and the electrical pressure contact mechanism 11 and the ground spring 17 to the two conductor electrical plug wire 10 to the steering wheel cowling. A jack cable 18 is installed in the steering wheel and fitted to a wire using the vehicle clockspring. This wire is sourced on the other side of the clockspring and connected to a plug cable 19 which plugs into the electronic control device 20. The electronic control device provides connections for harnesses 21, 22 and 23. The harnesses having specific uses to connect to the vehicle electrical circuitry for secondary functions. Secondary functions including, but not limited to; horn, turn signals, hi-beam, wiper, wash, cruise control and window up/down.

FIG. 5 shows a second embodiment of the present invention. This second embodiment of the device provides for a wireless radio frequency to transmit signals from the steering wheel rotating apparatus 1 to a receiver in the electronic control device 20 having an antenna 24. This alternate embodiment can be used when the vehicle steering column does not provide adequate electrical properties for the first embodiment to function.

What is claimed is:

1. A steering wheel rotating apparatus with electrical contact mechanisms for physically handicapped persons comprising:
an array of electrical contact mechanisms providing means to operate vehicle secondary operations.
a grip holder having electrical pressure contact surface and ground srping to provide electrical signals from the rotary grip to an electronic control device; and
having a control device establishing vehicle operation from operation of a specific electrical contact mechanisms on the rotating apparatus.

2. A rotary grip with positions provided to place electrical contact mechanisms in a variety of most useful locations for the physically handicapped vehicle operator; and
having selectable operation of vehicle secondary operations by a particular electrical contact mechanisms.

3. When a non-physically handicapped person is to operate the steering wheel, the rotary grip may be removed so as not to interfere with steering wheel operation or original equipment controls for secondary vehicle functions. The electrical contact surface provides an electrical disconnect and does not interfere with original vehicle equipment operation.

4. An electrical pressure contact surface for transmittal of electrical signals from the electrical contact mechanisms on the steering wheel rotating apparatus to the steering wheel wiring for connection to the control device.

5. A microcomputer programmed to determine the duration of the contact with the electrical contact mechanism, the microcomputer program can activate different operations based on the duration of the operate employing the electrical contact mechanism. This permits more operations than electrical contact mechanisms on the a steering wheel rotating apparatus.
